(19) United States
(12) Patent Application Publication
(10) Pub. No.: US 2025/0373831 A1
(43) Pub. Date: Dec. 4, 2025

(54) END-TO-END LEARNED CODEC FOR MULTIPLE BITRATES

(71) Applicant: Nokia Technologies Oy, Espoo (FI)

(72) Inventors: Francesco CRICRÌ, Tampere (FI); Nannan ZOU, Tampere (FI); Honglei ZHANG, Tampere (FI)

(21) Appl. No.: 19/201,270

(22) Filed: May 7, 2025

Related U.S. Application Data
(60) Provisional application No. 63/652,270, filed on May 28, 2024.

(51) Int. Cl. H04N 19/42; H04N 19/124

(52) U.S. Cl. CPC H04N 19/42; H04N 19/124

(57) ABSTRACT

Various embodiments provide methods, apparatuses, and computer program products. An example apparatus includes: at least one processor; and at least one memory storing instructions that, when executed by the at least one processor, cause the apparatus at least to perform: using a codec for coding an input to a first bitrate and/or a first reconstruction quality; using the codec for coding the input to a second bitrate and/or a second reconstruction quality; wherein the first bitrate is different from the second bitrate; and/or wherein the first reconstruction quality is different from the second reconstruction quality.

### TECHNICAL FIELD

The examples and non-limiting embodiments relate generally to multimedia transport and, more particularly to, implementing end-to-end learned codec for multiple bitrates.

### BACKGROUND

It is known to provide standardized formats for encoding, signaling, or decoding of media data.

### SUMMARY

Example 1: An apparatus comprising: at least one processor; and at least one memory storing instructions that, when executed by the at least one processor, cause the apparatus at least to perform: using a codec for coding an input to a first bitrate and/or a first reconstruction quality; using the codec for coding the input to a second bitrate and/or a second reconstruction quality; wherein the first bitrate is different from the second bitrate; and/or wherein the first reconstruction quality is different from the second reconstruction quality.

Example 2: The apparatus of example 1, wherein the apparatus is further caused to perform: coding the input to a third bitrate and/or a third reconstruction quality, wherein the third bitrate is different from the first bitrate and the second bitrate, and/or wherein the third reconstruction quality is different from the first reconstruction quality and the second reconstruction quality.

Example 3: The apparatus of any of examples 1 or 2, wherein the apparatus is further caused to perform: deriving, generating or determining one or more adaptation signals; wherein a probability model comprised in the codec is adapted based at least on the one or more adaptation signals or values of the one or more adaptation signals; or wherein a bitrate of a bitstream that is output by the apparatus or a reconstruction quality of an output by the apparatus depends on the one or more adaptation signals or the values of the one or more adaptation signals.

Example 4: The apparatus of example 3, wherein the apparatus is further caused to perform concatenating the one or more adaptation signals to one or more inputs to a probability model.

Example 5: The apparatus of example 3 or 4, wherein an input of one or more inputs to the probability model comprises a quantized latent tensor, wherein the quantized latent tensor is 3 dimensional (3D) representing height, width, and channels, and wherein an adaptation signal of the one or more adaptation signal comprises a 3D tensor with same or substantially same height and width as the quantized latent tensor, and wherein a number of channels of the adaptation signal is same as or different from a number of channels of the quantized latent tensor, and wherein the apparatus is further caused to perform: concatenating the adaptation signal to the quantized latent tensor across the channel dimension to generate an adapted latent tensor; and providing the adapted latent tensor as an input to the probability model.

Example 6: The apparatus of example 3, wherein the one or more adaptation signals modulate one or more inputs to the probability model.

Example 7: The apparatus of example 3 or 6, wherein one or more inputs to the probability model comprise one or more quantized latent tensors, and wherein the one or more adaptation signals are multiplied by the one or more quantized latent tensors.

Example 8: The apparatus of example 3 or 6, wherein one or more inputs to the probability model comprise one or more quantized latent tensors, and wherein the one or more adaptation signals are added to the one or more quantized latent tensors.

Example 9: The apparatus of example 3 or 6, wherein one or more inputs to the probability model comprise one or more quantized latent tensors, and wherein the one or more adaptation signals comprise a first set of adaptation signals and a second set of adaptation signals, wherein the first set of adaptation signals are multiplied by the one or more quantized latent tensor to generate a first set of adapted latent tensors, and wherein the second adaptation signals are added to the first set adapted latent tensor to generate a second set of adapted latent tensors, and wherein the second set of adapted latent tensors represent a modulated input to the probability model.

Example 10: The apparatus of example 3, wherein one or more inputs to the probability model comprise one or more quantized latent tensors, and wherein the one or more adaptation signals modulate one or more intermediate tensors of the probability model.

Example 11: The apparatus of example 3 or 10, wherein the probability model comprises a neural network comprising a set of layers, wherein at least a subset of the set of layers output one or more feature tensors, and wherein the one or more adaptation signals are used to modulate the one or more feature tensors.

Example 12: The apparatus of example 3, wherein the one or more adaptation signals comprises one or more weights or parameters and are used to update or replace respective one or more weights or parameters of the probability model.

Example 13: The apparatus of example 3, wherein the one or more adaptation signals are derived based on a target bitrate or a target reconstruction quality.

Example 14: The apparatus of example 3, wherein the one or more adaptation signals are determined offline by using a training process.

Example 15: The apparatus of any of examples 1 or 2, wherein the apparatus is further caused to perform: generating or determining two or more adaptation signals comprising two or more tensors, wherein values of the two or more tensors are learned by means of gradient descent based optimization or minimization of respective two or more rate-distortion loss functions with respect to the two or more tensors, wherein the two or more rate-distortion functions use respective two or more lambda values, wherein the two or more lambda values are multiplied by respective two or more rate terms in the respective two or more rate-distortion loss functions; and using the two or more adaptation signals, at inference time, to achieve respective two or more bitrates and/or two or more reconstruction qualities.

Example 16: The apparatus of example 3, wherein the one or more adaptation signals are generated by one or more neural network layers, wherein weights or parameters of the one or more neural network layers are determined offline by means of a training process.

Example 17: The apparatus of example 16, wherein the one or more neural network layers comprise a first set of neural network layers and a second set of neural network layers, wherein the first set of neural network layers output a first set of adaptation signals and a second set of neural network layers output a second set of adaptation signals, and wherein the first set of adaptation signals are multiplied by one or more inputs or intermediate outputs of the probability model, and wherein the second set of adaptation signals is added to the one or more inputs or the intermediate outputs of the probability model.

Example 18: The apparatus of example 3, wherein the one or more adaptation signals are determined online by optimizing an optimization objective with respect to the one or more adaptation signals.

Example 19: The apparatus of example 3, wherein each of the one or more adaptation signals comprise a tensor that is concatenated to an input to the probability model, and wherein the tensor is determined or learned based on gradient descent based optimization of an optimization objective by using backpropagation, and wherein the optimization objective is a rate-distortion loss function.

Example 20: The apparatus of example 3, wherein the one or more adaptation signals are output by one or more neural network layers, wherein parameters of the one or more neural network layers are learned or determined at inference time by optimizing an optimization objective.

Example 21: The apparatus of example 3, wherein an adaptation signal of the one or more adaptation signals is same or substantially same as a signal that is used to adapt a latent tensor that is output by a neural network based encoder or a quantized latent tensor.

Example 22: The apparatus of example 3, wherein: the one or more adaptation signals are output by one or more first neural network layers; one or more parameters of the one or more first neural network layers are generated by one or more second neural network layers; and an input to the one or more second neural network layers comprises one or more initial adaptation signals, or one or more values derived from a lambda value that was used to weight the rate term of a rate-distortion loss function, or a value that represents a target bitrate or target reconstruction quality.

Example 23: The apparatus of example 3, wherein each of the one or more adaptation signals comprises a 1 dimensional (1D) tensor or a 1D array.

Example 24: The apparatus of example 23, wherein a size of the 1D tensor or the 1D array comprises a number of channels of a tensor that the each adaptation signal adapts or modulates.

Example 25: The apparatus of example 3, wherein each of the one or more adaptation signals comprises a tensor with same size as a tensor that the each adaptation signal adapts or modulates.

Example 26: The apparatus of example 3, wherein each of the one or more adaptation signals comprises a 3 dimensional (3D) tensor comprising 3 dimensions, wherein a first dimension of the three dimensions spans over channels of the 3D tensor, a second dimension of the three dimensions spans over vertical spatial elements, and a third dimension of the three dimensions spans over horizontal spatial elements.

Example 27: The apparatus of example 3, wherein each of the one or more adaptation signals comprises a 4 dimensional (4D) tensor, with dimensions for batch of samples, channels, height, and width.

Example 28: The apparatus of any of the examples 3 to 27, wherein the apparatus is further caused to perform: signaling, in or along a bitstream, the one or more adaptation signals, or one or more values from which the one or more adaptation signals are derived, and wherein the adaptation signals are used at an encoder side to adapt the probability model that is used to produce estimated probabilities for one or more symbols to be encoded, and are used at decoder side to adapt a probability model that is used to produce estimated probabilities for one or more symbols to be decoded.

Example 29: The apparatus of example 1, wherein the apparatus is further caused to perform: signaling, in or along a bitstream, information about a bitrate or quality, wherein the information about the bitrate or quality is used to derive an adaptation signal, and wherein the adaptation signal is used to adapt one or more features of the probability model.

Example 30: The apparatus of any of the examples 3 to 27, wherein the apparatus is further caused to perform: signaling, in or along a bitstream, information about a type of adaptation to be performed on the probability model based at least on the one or more adaptation signals.

Example 31: The apparatus of any of the examples 3 to 27, wherein the apparatus is further caused to perform: signaling, in or along a bitstream, information about how one or more adaptation signals are derived from one or more values.

Example 32: The apparatus of any of the examples 3 to 27, wherein the apparatus is further caused to perform: signaling, in or along a bitstream, a residual of each of the one or more adaptation signal, wherein the residual is combined with a predicted adaptation signal that is predicted at decoder side, obtaining a combined adaptation signal, and wherein the combined adaptation signal is used to adapt the probability model to achieve a desired bitrate and/or reconstruction quality.

Example 33: The apparatus of any of the examples 3 to 27, wherein the apparatus is further caused to perform: receiving, from or along a bitstream, the one or more adaptation signals, or one or more values from which the one or more adaptation signals are derived, and wherein the adaptation signals are used at an encoder side to adapt the probability model that is used to produce estimated probabilities for one or more symbols to be encoded; and adapting the probability model to produce estimated probabilities for one or more symbols to be decoded.

Example 34: The apparatus of example 1, wherein the apparatus is further caused to perform: receiving, from or along a bitstream, information about a bitrate or a reconstruction quality; deriving one or more adaptation signals based at least on the information; using the one or more adaptation signals for adapting one or more features of a probability model comprised in the codec, wherein a quality of an output of a decoder of the codec depends on the one or more adaptation signals, and wherein different adaptation signals result in the decoder producing outputs of different qualities.

Example 35: The apparatus of any of the examples 3 to 27, wherein the apparatus is further caused to perform: receiving, from or along a bitstream, information about a type of adaptation to be performed on the probability model based at least on the one or more adaptation signals.

Example 36: The apparatus of any of the examples 3 to 27, wherein the apparatus is further caused to perform: receiving, from or along a bitstream, information about how one or more adaptation signals are derived from one or more values.

Example 37: The apparatus of any of the examples 3 to 27, wherein the apparatus is further caused to perform: receiving, from or along a bitstream, a residual of each of the one or more adaptation signal; combining the residual with a predicted adaptation signal that is predicted at a decoder side to generate a combined adaptation signal; and using the combined adaptation signal for adapting the probability model comprised in the codec for achieving a desired reconstruction quality.

Example 38: A method comprising: using a codec for coding an input to a first bitrate and/or a first reconstruction quality; using the codec for coding the input to a second bitrate and/or a second reconstruction quality; wherein the first bitrate is different from the second bitrate; and/or wherein the first reconstruction quality is different from the second reconstruction quality.

Example 39: The method of example 38, further comprising: coding the input to a third bitrate and/or a third reconstruction quality, wherein the third bitrate is different from the first bitrate and the second bitrate, and/or wherein the third reconstruction quality is different from the first reconstruction quality and the second reconstruction quality.

Example 40: The method of any of examples 38 or 39 further comprising: deriving, generating or determining one or more adaptation signals; wherein a probability model comprised in the codec is adapted based at least on the one or more adaptation signals or values of the one or more adaptation signals; or wherein a bitrate of a bitstream that is output by an encoder or a reconstruction quality of an output by a decoder depends on the one or more adaptation signals or the values of the one or more adaptation signals.

Example 41: The method of example 40, further comprising concatenating the one or more adaptation signals to one or more inputs to a probability model.

Example 42: The method of example 40 or 41, wherein an input of one or more inputs to the probability model comprises a quantized latent tensor, wherein the quantized latent tensor is 3 dimensional (3D) representing height, width, and channels, and wherein an adaptation signal of the one or more adaptation signal comprises a 3D tensor with same or substantially same height and width as the quantized latent tensor, and wherein a number of channels of the adaptation signal is same as or different from a number of channels of the quantized latent tensor, and wherein the method further comprises: concatenating the adaptation signal to the quantized latent tensor across the channel dimension to generate an adapted latent tensor; and providing the adapted latent tensor as an input to the probability model.

Example 43: The method of example 40, wherein the one or more adaptation signals modulate one or more inputs to the probability model.

Example 44: The method of example 40 or 43, wherein one or more inputs to the probability model comprise one or more quantized latent tensors, and wherein the one or more adaptation signals are multiplied by the one or more quantized latent tensors.

Example 45: The method of example 40 or 43, wherein one or more inputs to the probability model comprise one or more quantized latent tensors, and wherein the one or more adaptation signals are added to the one or more quantized latent tensors.

Example 46: The method of example 40 or 43, wherein one or more inputs to the probability model comprise one or more quantized latent tensors, and wherein the one or more adaptation signals comprise a first set of adaptation signals and a second set of adaptation signals, wherein the first set of adaptation signals are multiplied by the one or more quantized latent tensor to generate a first set of adapted latent tensors, and wherein the second adaptation signals are added to the first set adapted latent tensor to generate a second set of adapted latent tensors, and wherein the second set of adapted latent tensors represent a modulated input to the probability model.

Example 47: The method of example 40, wherein one or more inputs to the probability model comprise one or more quantized latent tensors, and wherein the one or more adaptation signals modulate one or more intermediate tensors of the probability model.

Example 48: The method of example 40 or 47, wherein the probability model comprises a neural network comprising a set of layers, wherein at least a subset of the set of layers output one or more feature tensors, and wherein the one or more adaptation signals are used to modulate the one or more feature tensors.

Example 49: The method of example 40, wherein the one or more adaptation signals comprises one or more weights or parameters and are used to update or replace respective one or more weights or parameters of the probability model.

Example 50: The method of example 40, wherein the one or more adaptation signals are derived based on a target bitrate or a target reconstruction quality.

Example 51: The method of example 40, wherein the one or more adaptation signals are determined offline by using a training process.

Example 52: The method of any of examples 38 or 39, further comprising:
generating or determining two or more adaptation signals comprising two or more tensors, wherein values of the two or more tensors are learned by means of gradient descent based optimization or minimization of respective two or more rate-distortion loss functions with respect to the two or more tensors, wherein the two or more rate-distortion functions use respective two or more lambda values, wherein the two or more lambda values are multiplied by respective two or more rate terms in the respective two or more rate-distortion loss functions; and using the two or more adaptation signals, at inference time, to achieve respective two or more bitrates and/or two or more reconstruction qualities.

Example 53: The method of example 40, wherein the one or more adaptation signals are generated by one or more neural network layers, wherein weights or parameters of the one or more neural network layers are determined offline by means of a training process.

Example 54: The method of example 53, wherein the one or more neural network layers comprise a first set of neural network layers and a second set of neural network layers, wherein the first set of neural network layers output a first set of adaptation signals and a second set of neural network layers output a second set of adaptation signals, and wherein the first set of adaptation signals are multiplied by one or more inputs or intermediate outputs of the probability model, and wherein the second set of adaptation signals is added to the one or more inputs or the intermediate outputs of the probability model.

Example 55: The method of example 40, wherein the one or more adaptation signals are determined online by optimizing an optimization objective with respect to the one or more adaptation signals.

Example 56: The method of example 40, wherein each of the one or more adaptation signals comprise a tensor that is concatenated to an input to the probability model, and wherein the tensor is determined or learned based on gradient descent based optimization of an optimization objective by using backpropagation, and wherein the optimization objective is a rate-distortion loss function.

Example 57: The method of example 40, wherein the one or more adaptation signals are output by one or more neural network layers, wherein parameters of the one or more neural network layers are learned or determined at inference time by optimizing an optimization objective.

Example 58: The method of example 40, wherein an adaptation signal of the one or more adaptation signals is same or substantially same as a signal that is used to adapt a latent tensor that is output by a neural network based encoder or a quantized latent tensor.

Example 59: The method of example 40, wherein: the one or more adaptation signals are output by one or more first neural network layers; one or more parameters of the one or more first neural network layers are generated by one or more second neural network layers; and an input to the one or more second neural network layers comprises one or more initial adaptation signals, or one or more values derived from a lambda value that was used to weight the rate term of a rate-distortion loss function, or a value that represents a target bitrate or target reconstruction quality.

Example 60: The method of example 40, wherein each of the one or more adaptation signals comprises a 1 dimensional (1D) tensor or a 1D array.

Example 61: The method of example 60, wherein a size of the 1D tensor or the 1D array comprises a number of channels of a tensor that the each adaptation signal adapts or modulates.

Example 62: The method of example 40, wherein each of the one or more adaptation signals comprises a tensor with same size as a tensor that the each adaptation signal adapts or modulates.

Example 63: The method of example 40, wherein each of the one or more adaptation signals comprises a 3 dimensional (3D) tensor comprising 3 dimensions, wherein a first dimension of the three dimensions spans over channels of the 3D tensor, a second dimension of the three dimensions spans over vertical spatial elements, and a third dimension of the three dimensions spans over horizontal spatial elements.

Example 64: The method of example 40, wherein each of the one or more adaptation signals comprises a 4 dimensional (4D) tensor, with dimensions for batch of samples, channels, height, and width.

Example 65: The method of any of the examples 40 to 64, further comprising: signaling, in or along a bitstream, the one or more adaptation signals, or one or more values from which the one or more adaptation signals are derived, and wherein the adaptation signals are used at an encoder side to adapt the probability model that is used to produce estimated probabilities for one or more symbols to be encoded, and are used at decoder side to adapt a probability model that is used to produce estimated probabilities for one or more symbols to be decoded.

Example 66: The method of example 38, further comprising: signaling, in or along a bitstream, information about a bitrate or quality, wherein the information about the bitrate or quality is used to derive an adaptation signal, and wherein the adaptation signal is used to adapt one or more features of the probability model.

Example 67: The method of any of the examples 40 to 64, further comprising:
signaling, in or along a bitstream, information about a type of adaptation to be performed on the probability model based at least on the one or more adaptation signals.

Example 68: The method of any of the examples 40 to 64, further comprising:
signaling, in or along a bitstream, information about how one or more adaptation signals are derived from one or more values.

Example 69: The method of any of the examples 40 to 64, further comprising:
signaling, in or along a bitstream, a residual of each of the one or more adaptation signal, wherein the residual is combined with a predicted adaptation signal that is predicted at decoder side, obtaining a combined adaptation signal, and wherein the combined adaptation signal is used to adapt the probability model to achieve a desired bitrate and/or reconstruction quality.

Example 70: The method of any of the examples 40 to 64, further comprising:
receiving, from or along a bitstream, the one or more adaptation signals, or one or more values from which the one or more adaptation signals are derived, and wherein the adaptation signals are used at an encoder side to adapt the probability model that is used to produce estimated probabilities for one or more symbols to be encoded; and adapting the probability model to produce estimated probabilities for one or more symbols to be decoded.

Example 71: The method of example 38, further comprising: receiving, from or along a bitstream, information about a bitrate or a reconstruction quality; deriving one or more adaptation signals based at least on the information; using the one or more adaptation signals for adapting one or more features of a probability model comprised in the codec, wherein a quality of an output of a decoder of the codec depends on the one or more adaptation signals, and wherein different adaptation signals result in the decoder producing outputs of different qualities.

Example 72: The method of any of the examples 40 to 64, further comprising:
receiving, from or along a bitstream, information about a type of adaptation to be performed on the probability model based at least on the one or more adaptation signals.

Example 73: The method of any of the examples 40 to 64, further comprising: receiving, from or along a bitstream, information about how one or more adaptation signals are derived from one or more values.

Example 74: The method of any of the examples 40 to 64, further comprising: receiving, from or along a bitstream, a residual of each of the one or more adaptation signal; combining the residual with a predicted adaptation signal that is predicted at a decoder side to generate a combined adaptation signal; and using the combined adaptation signal for adapting the probability model comprised in the codec for achieving a desired reconstruction quality.

Example 75: An apparatus comprising: means for using a codec for coding an input to a first bitrate and/or a first reconstruction quality; means for using the codec for coding the input to a second bitrate and/or a second reconstruction quality; wherein the first bitrate is different from the second bitrate; and/or wherein the first reconstruction quality is different from the second reconstruction quality.

Example 76: The apparatus of example 75, wherein the apparatus further comprises means for performing methods as described in any of the examples 39 to 74.

Example 77: A computer readable medium comprising program instructions that, when executed by an apparatus, cause the apparatus to perform: using a codec for coding an input to a first bitrate and/or a first reconstruction quality; using the codec for coding the input to a second bitrate and/or a second reconstruction quality; wherein the first bitrate is different from the second bitrate; and/or wherein the first reconstruction quality is different from the second reconstruction quality.

Example 78: The computer readable medium comprising program instructions that, when executed by an apparatus, further cause the apparatus to perform the methods as described in any of the examples 39 to 74.

Example 79: The computer readable medium of any of examples 77 or 78, wherein the computer readable medium comprises a non-transitory computer readable medium.

Example 80: An apparatus comprising: at least one processor; and at least one memory storing instructions that, when executed by the at least one processor, cause the apparatus at least to perform: deriving, generating or determining one or more adaptation signals; wherein a probability model comprised in a codec is adapted based at least on the one or more adaptation signals or one or more values of the one or more adaptation signals; or wherein a bitrate of a bitstream that is output by the apparatus and/or a reconstruction quality of an output by the apparatus depends on the one or more adaptation signals or the one or more values of the one or more adaptation signals.

Example 81: A method comprising: deriving, generating or determining one or more adaptation signals; wherein a probability model comprised in a codec is adapted based at least on the one or more adaptation signals or one or more values of the one or more adaptation signals; or wherein a bitrate of a bitstream that is output by an encoder and/or a reconstruction quality of an output by a decoder depends on the one or more adaptation signals or the one or more values of the one or more adaptation signals.

Example 82: A non-transitory computer readable medium comprising program instructions that, when executed by an apparatus, cause the apparatus to perform: deriving, generating or determining one or more adaptation signals; wherein a probability model comprised in a codec is adapted based at least on the one or more adaptation signals or one or more values of the one or more adaptation signals; or wherein a bitrate of a bitstream that is output by an encoder and/or a reconstruction quality of an output by a decoder depends on the one or more adaptation signals or the one or more values of the one or more adaptation signals.

### BRIEF DESCRIPTION OF THE DRAWINGS

The foregoing embodiments and other features are explained in the following description, taken in connection with the accompanying drawings, wherein:

FIG. 1 shows schematically an apparatus employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 is a block diagram illustrating a system in accordance with an example.

FIG. 5 illustrates an example of modified video coding pipeline based on neural networks.

FIG. 6 illustrates an example neural network-based end-to-end learned codec, such as an end-to-end learned video codec.

FIG. 7 illustrates an example pipeline performing video coding for machines.

FIG. 8 illustrates an example neural network-based end-to-end learned codec, such as an end-to-end learned video codec, based on an embodiment.

FIG. 9 illustrates an example neural network-based end-to-end learned codec, such as an end-to-end learned video codec, based on another embodiment.

FIG. 10 is an example apparatus, which may be implemented in hardware, and is caused to, implement examples described herein.

FIG. 11 shows a representation of an example of non-volatile memory media used to store instructions that implement the examples described herein.

FIG. 12 is an example method performed with an encoder or a decoder, based on the examples described herein.

FIG. 13 is an example method performed with an encoder, based on the examples described herein.

FIG. 14 is an example method performed with a decoder, based on the example embodiments described herein.

FIG. 15 is an example method performed with an encoder or a decoder, based on the examples described herein.

### DETAILED DESCRIPTION OF EXAMPLE EMBODIMENTS

The following acronyms and abbreviations that may be found in the specification and/or the drawing figures are defined as follows (the abbreviations may be appended with each other or with other characters using e.g. a hyphen or dash (-), and may be case insensitive):
4CC four character code
5G fifth generation cellular network technology
5GC 5G core network
a.k.a. also known as
AVC advanced video coding
CU coding unit
DSP digital signal processor
DU distributed unit
eNB (or eNodeB) evolved Node B (for example, an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, for example, the LTE radio access technology
F1 or F1-C interface between CU and DU control interface
gNB (or gNodeB) base station for 5G/NR, for example, a node providing NR user plane and control plane protocol terminations towards the UE, and connected via the NG interface to the 5GC
IEC International Electrotechnical Commission
IoT internet of things
ISO International Organization for Standardization
ISOBMFF ISO base media file format
JPEG joint photographic experts group
LTE long-term evolution
mdat MediaDataBox
MIME Multipurpose Internet Mail Extension
MME mobility management entity
moov MovieBox
MP4 file format for MPEG-4 Part 14 files
MPEG moving picture experts group
MPEG-2 H.222/H.262 as defined by the ITU
MPEG-4 audio and video coding standard for ISO/IEC 14496
ng or NG new generation
ng-eNB or NG-eNB new generation eNB
NR new radio (5G radio)
N/W or NW network
PDCP packet data convergence protocol
PHY physical layer
PNG portable network graphics
RAN radio access network
RFC request for comments
RLC radio link control
RRC radio resource control
RRH remote radio head
RU radio unit
Rx receiver
SDAP service data adaptation protocol
SGW serving gateway
SMF session management function
SPS sequence parameter set
SVC scalable video coding
S1 interface between eNodeBs and the EPC
trak TrackBox Tx transmitter
UE user equipment
UICC Universal Integrated Circuit Card
UPF user plane function
URL uniform resource locator
X2 interconnecting interface between two eNodeBs in LTE network
Xn interface between two NG-RAN nodes

Some embodiments will now be described more fully hereinafter with reference to the accompanying drawings, in which some, but not all, embodiments may be shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms ‘data,’ ‘content,’ ‘information,’ and similar terms may be used interchangeably to refer to data capable of being transmitted, received and/or stored in accordance with embodiments of the present invention. Thus, use of any such terms should not be taken to limit the spirit and scope of embodiments.

Described herein is a method and apparatus for implementing end-to-end learned codec for multiple bitrates.

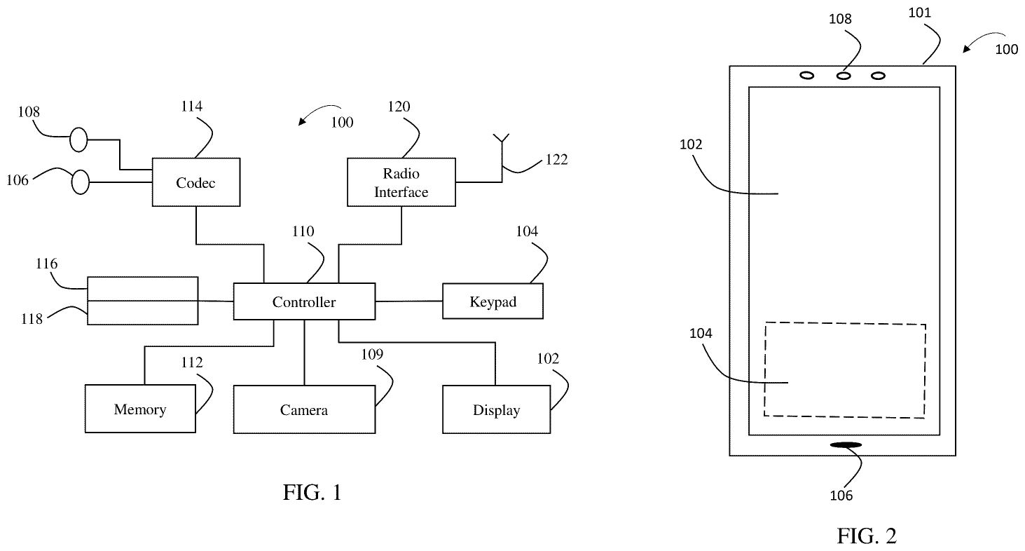

The following describes in detail a suitable apparatus and possible method for implementing end-to-end learned codec for multiple bitrates according to embodiments. In this regard reference is first made to FIG. 1 and FIG. 2, where FIG. 1 shows an example block diagram of an electronic device or apparatus 100. The apparatus 100 may be an Internet of Things (IoT) apparatus configured to perform various functions, such as for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 are explained next.

The apparatus 100 may for example be a mobile terminal or user equipment of a wireless communication system, a sensor device, a tag, or other lower power device. However, it would be appreciated that embodiments of the examples described herein may be implemented within any electronic device or apparatus which may process data by neural networks.

The apparatus 100 may comprise a housing 101 for incorporating and protecting the device. The apparatus 100 further may comprise a display 102 in the form of a liquid crystal display. In other embodiments of the examples described herein the display may be any suitable display technology suitable to display an image or video. The apparatus 100 may further comprise a keypad 104. In other embodiments of the examples described herein any suitable data or user interface mechanism may be employed. For example the user interface may be implemented as a virtual keyboard or data entry system as part of a touch-sensitive display.

The apparatus may comprise a microphone 106 or any suitable audio input which may be a digital or analog signal input. The apparatus 100 may further comprise an audio output device which in embodiments of the examples described herein may be any one of: an earpiece 108, speaker, or an analog audio or digital audio output connection. The apparatus 100 may also comprise a battery (or in other embodiments of the examples described herein the device may be powered by any suitable mobile energy device such as solar cell, fuel cell or clockwork generator). The apparatus 100 may further comprise a camera 109 capable of recording or capturing images and/or video. The apparatus 100 may further comprise an infrared port for short range line of sight communication to other devices. In other embodiments the apparatus 100 may further comprise any suitable short range communication solution such as for example a Bluetooth wireless connection or a USB/firewire wired connection.

The apparatus 100 may comprise a controller 110, processor or processor circuitry for controlling the apparatus 100. The controller 110 may be connected to memory 112 which in embodiments of the examples described herein may store both data in the form of image and audio data and/or may also store instructions for implementation on the controller 110. The controller 110 may further be connected to codec circuitry 114 suitable for carrying out coding and/or decoding of audio and/or video data or assisting in coding and/or decoding carried out by the controller.

The apparatus 100 may further comprise a card reader 118 and a smart card 116, for example a UICC and UICC reader for providing user information and being suitable for providing authentication information for authentication and authorization of the user at a network.

The apparatus 100 may comprise radio interface circuitry 120 connected to the controller and suitable for generating wireless communication signals for example for communication with a cellular communications network, a wireless communications system or a wireless local area network. The apparatus 100 may further comprise an antenna 122 connected to the radio interface circuitry 120 for transmitting radio frequency signals generated at the radio interface circuitry 120 to other apparatus(es) and/or for receiving radio frequency signals from other apparatus(es).

The apparatus 100 may comprise a camera capable of recording or detecting individual frames which are then passed to the codec circuitry 114 or the controller for processing. The apparatus may receive the video image data for processing from another device prior to transmission and/or storage. The apparatus 100 may also receive either wirelessly or by a wired connection the image for coding/decoding. The structural elements of apparatus 100 described above represent examples of means for performing a corresponding function.

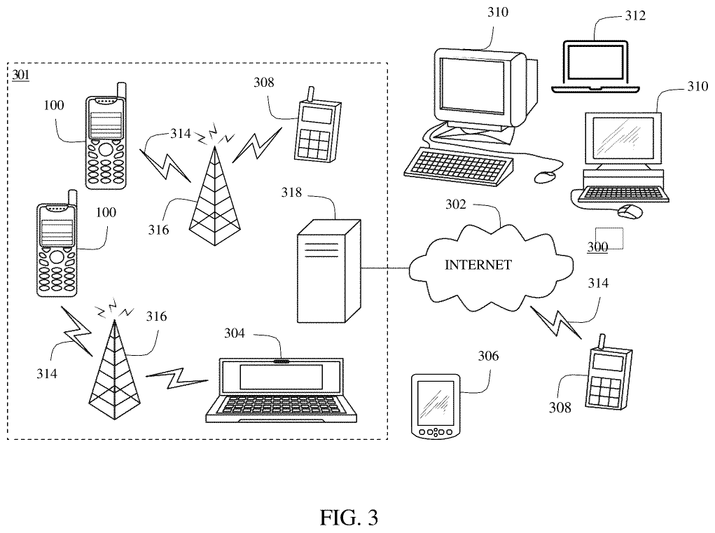

With respect to FIG. 3, an example of a system within which embodiments of the examples described herein can be utilized is shown. The system 300 comprises multiple communication devices which can communicate through one or more networks. The system 300 may comprise any combination of wired or wireless networks including, but not limited to a wireless cellular telephone network (such as a GSM, UMTS, CDMA, LTE, 4G, 5G network, etc.), a wireless local area network (WLAN) such as defined by any of the IEEE 802.x standards, a Bluetooth personal area network, an Ethernet local area network, a token ring local area network, a wide area network, and the Internet.

The system 300 may include both wired and wireless communication devices and/or apparatus 100 suitable for implementing embodiments of the examples described herein.

For example, the system shown in FIG. 3 shows a mobile telephone network 301 and a representation of the internet 302. Connectivity to the internet 302 may include, but is not limited to, long range wireless connections, short range wireless connections, and various wired connections including, but not limited to, telephone lines, cable lines, power lines, and similar communication pathways.

The example communication devices shown in the system 300 may include, but are not limited to, an electronic device or apparatus 100, a combination of a personal digital assistant (PDA) and a mobile telephone 304, a PDA 306, an integrated messaging device (IMD) 308, a desktop computer 310, a notebook computer 312, or a head-mounted apparatus. The head-mounted apparatus may be a head-mounted display (HMD), or glasses having a device such as a camera configured to encode and/or decode images and/or video. The apparatus 100 may be stationary or mobile when carried by an individual who is moving. The apparatus 100 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; e.g., a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 314 to a base station 316. The base station 316 may be connected to a network server 318 that allows communication between the mobile telephone network 301 and the internet 302. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the Internet of Things (IoT). In order to utilize the Internet IoT devices are provided with an IP address as a unique identifier. IoT devices may be provided with a radio transmitter, such as a WLAN or Bluetooth transmitter or a RFID tag. Alternatively, IoT devices may have access to an IP-based network via a wired network, such as an Ethernet-based network or a power-line connection (PLC).

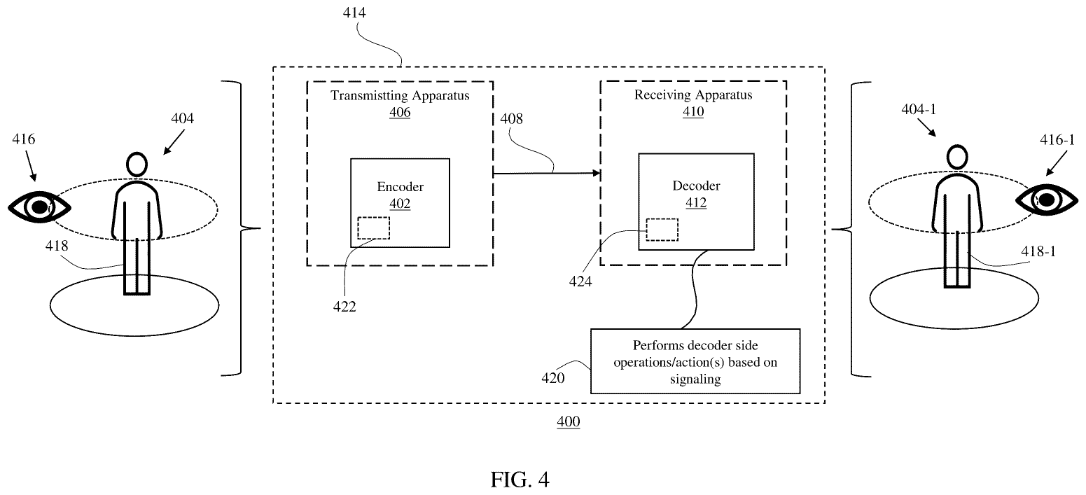

FIG. 4 is a block diagram illustrating a system or apparatus 400 in accordance with several examples. In an example, the encoder 402 is used to encode an image or video from the scene 404, and the encoder 402 is implemented in a transmitting apparatus 406. The encoder 402 produces a bitstream 408 comprising signaling that is received by the receiving apparatus 410, which implements a decoder 412. The encoder 402 sends the bitstream 408 that comprises the herein described signaling. The decoder 412 forms the image or video for the scene 404-1, and the receiving apparatus 410 would present this to the user, e.g., via a smartphone, television, or projector among many other options.

In some examples, the transmitting apparatus 406 and the receiving apparatus 410 are at least partially within a common apparatus, and for example, are located within a common housing 414. In other examples the transmitting apparatus 406 and the receiving apparatus 410 are at least partially not within a common apparatus and have at least partially different housings. Therefore in some examples, the encoder 402 and the decoder 412 are at least partially within a common apparatus, and for example are located within a common housing 414. For example, the common apparatus comprising the encoder 402 and decoder 412 implements a codec. In other examples, the encoder 402 and the decoder 412 are at least partially not within a common apparatus and have at least partially different housings, but when together still implement a codec.

In some examples, 3D media from the capture (e.g., volumetric capture) at a viewpoint 416 of the scene 404, which includes a person 418) is converted via projection to a series of 2D representations with occupancy, geometry, attributes and/or displacements. Additional atlas information is also included in the bitstream to enable inverse reconstruction. For decoding, the received bitstream 408 is separated into its components with atlas information; occupancy, geometry, displacement, and attribute 2D representations. A 3D reconstruction is performed to reconstruct the scene 404-1 created looking at the viewpoint 416-1 with a “reconstructed” person 418-1. The “−1” are used to indicate that these are reconstructions of the original. As indicated at 420, the decoder 412 performs an operation(s) or action(s) based on the received signaling.

Encoding 422 generates bitstreams of different bitrates, based on the example described herein. In an example, a bitrate of a bitstream depends on an adaptation signal. Decoding 424 generates outputs of different qualities, based on the examples described herein. In an example, a quality of an output depends on an adaptation signal.

Having thus introduced a suitable but non-limiting technical context for the practice of the example embodiments of the present disclosure, example embodiments will now be described in detail.

### Fundamentals of Neural Networks

A neural network (NN) may be described as a computation graph comprising several layers of computation. Each layer may include one or more units, where each unit performs an elementary computation. A unit is connected to one or more other units, and the connection may be associated with a weight. The weight may be used for scaling the signal passing through the associated connection. Weights are learnable parameters, e.g., values which can be learned from training data. There may be other learnable parameters, such as those of batch-normalization layers.

In some neural networks, such as convolutional neural networks for image classification, initial layers (those close to the input data) extract semantically low-level features such as edges and textures in images, whereas intermediate layers extract more high-level features. After the feature extraction layers there may be one or more layers performing a certain task, such as classification, semantic segmentation, object detection, denoising, style transfer, super-resolution, and the like.

Neural networks are being utilized in an ever-increasing number of applications for many different types of devices, such as mobile phones. Examples include image and video analysis and processing, social media data analysis, device usage data analysis, and the like.

One property of neural nets (and other machine learning tools) is that they are able to learn properties from input data, e.g., in a supervised way or in unsupervised way. Such learning is a result of a training algorithm, or of a meta-level neural network providing the training signal.

In general, the training algorithm includes changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss or loss function. Examples of losses are mean squared error, cross-entropy, etc. In recent deep learning techniques, training is an iterative process, where at each iteration the algorithm modifies the weights of the neural net to make a gradual improvement of the network's output, e.g., to gradually decrease the loss, by means of gradient descent technique. In one example, at each training iteration, gradients of the loss function with respect to one or more weights or parameters of the NN are computed, for example by backpropagation technique; the computed gradients are then used by an optimization routine, such as Adam or Stochastic Gradient Descent (SGD) to obtain an update to the one or more weights or parameters.

In various embodiment, the terms “model”, “neural network”, “neural net” and “network” may be used interchangeably, and also the weights of neural networks are sometimes referred to as learnable parameters or simply as parameters.

Training a neural network is an optimization process, but the final goal may be different from the typical goal of optimization. In optimization, the only goal is to minimize a function. In machine learning, the goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization. In practice, data is usually split into at least two sets, the training set and the validation set. The training set is used for training the network, e.g., to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following things:
when the network is learning at all—in this case, the training set error should decrease, otherwise the model is in the regime of underfitting.
when the network is learning to generalize—in this case, also the validation set error needs to decrease and to be not too much higher than the training set error. When the training set error is low, but the validation set error is much higher than the training set error, or it does not decrease, or it even increases, the model may be in the regime of overfitting. This means that the model has just memorized the training set's properties and performs well only on that set, but performs poorly on a set not used for tuning its parameters.

### Fundamentals of Video/Image Coding

Video codec includes an encoder that transforms the input video into a compressed representation suited for storage/transmission and a decoder that can decompress the compressed video representation back into a viewable form. Typically, an encoder discards some information in the original video sequence in order to represent the video in a more compact form (that is, at lower bitrate).

Typical hybrid video codecs, for example ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, e.g., the difference between the predicted block of pixels and the original block of pixels, is coded. This is typically done by transforming the difference in pixel values using a specified transform (e.g., Discrete Cosine Transform (DCT) or a variant of it), quantizing the coefficients and entropy coding the quantized coefficients. By varying the fidelity of the quantization process, the encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, exploits temporal redundancy. In inter prediction the sources of prediction are previously decoded pictures (a.k.a. reference pictures).

In temporal inter prediction, the sources of prediction are previously decoded pictures in the same scalable layer. In intra block copy (IBC; a.k.a. intra-block-copy prediction), prediction may be applied similarly to temporal inter prediction but the reference picture is the current picture and only previously decoded samples may be referred in the prediction process. Inter-layer or inter-view prediction may be applied similarly to temporal inter prediction, but the reference picture is a decoded picture from another scalable layer or from another view, respectively. In some cases, inter prediction may refer to temporal inter prediction only, while in other cases inter prediction may refer collectively to temporal inter prediction and any of intra block copy, inter-layer prediction, and inter-view prediction provided that they are performed with the same or similar process than temporal prediction. Inter prediction, temporal inter prediction, or temporal prediction may sometimes be referred to as motion compensation or motion-compensated prediction.

Intra prediction utilizes the fact that adjacent pixels within the same picture are likely to be correlated. Intra prediction can be performed in spatial or transform domain, e.g., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

In typical video codecs the motion information is indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently those are typically coded differentially with respect to block specific predicted motion vectors. In typical video codecs the predicted motion vectors are created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or or co-located blocks in temporal reference picture. Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signaled among a list of motion field candidate list filled with motion field information of available adjacent/co-located blocks.

In typical video codecs the prediction residual after motion compensation is first transformed with a transform kernel (like DCT) and then coded. The reason for this is that often there still exists some correlation among the residual and transform can in many cases help reduce this correlation and provide more efficient coding.

Typical video encoders utilize Lagrangian cost functions to find optimal coding modes, e.g., the desired Macroblock mode and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R$$

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Video coding specifications may enable the use of supplemental enhancement information (SEI) messages or alike. Some video coding specifications include SEI NAL units, and some video coding specifications contain both prefix SEI NAL units and suffix SEI NAL units, where the former type can start a picture unit or alike and the latter type can end a picture unit or alike. An SEI NAL unit contains one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

### Information on Neural Network Based Image/Video Coding

Recently, neural networks (NNs) have been used in the context of image and video compression, by following mainly two approaches.

In an example approach, NNs are used to replace one or more of the components of a traditional codec such as a VVC/H.266-compliant codec. Here, by “traditional” we mean those codecs whose components and their parameters are typically not learned from data by means of machine learning techniques. Some examples of components that may be implemented as neural networks are, but not limited to:
An in-loop filter, for example a NN that works as an additional in-loop filter with respect to the traditional loop filters, or a NN that works as the only additional in-loop filter, thus replacing any other in-loop filter.
Intra-frame prediction.
Inter-frame prediction.
Transform and/or inverse transform.
Probability model for lossless coding.

In another example approach, commonly referred to as “end-to-end learned compression” (or end-to-end learned codec), NNs are used as the main components of the image/video codecs. However, the codec may still comprise components which are not based on machine learning techniques. In this approach, two example design options are as follows:

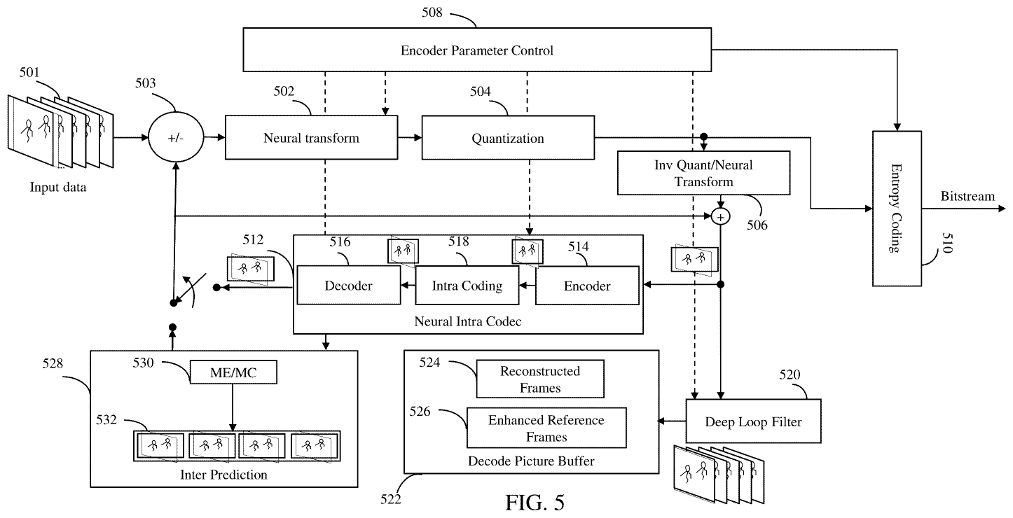

Option 1: re-use the traditional video coding pipeline, but replace most or all the components with NNs, as shown in FIG. 5.

Referring to FIG. 5, it illustrates an example of modified video coding pipeline based on neural networks. An example of neural network may include, but is not limited, a compressed representation of a neural network. FIG. 5 is shown to include following components:

A neural transform block or circuit 502: this block or circuit transforms the output of a summation/subtraction operation 503 to a new representation of that data, which may have lower entropy and thus be more compressible.

A quantization block or circuit 504: this block or circuit quantizes an input data 501 to a smaller set of possible values.

An inverse transform and inverse quantization blocks or circuits 506. These blocks or circuits perform the inverse or approximately inverse operation of the transform and the quantization, respectively.

An encoder parameter control block or circuit 508. This block or circuit may control and optimize some or all the parameters of the encoding process, such as parameters of one or more of the encoding blocks or circuits.

An entropy coding block or circuit 510. This block or circuit may perform lossless coding, for example, based on entropy. One popular entropy coding technique is arithmetic coding.

A neural intra-codec block or circuit 512. This block or circuit may be an image compression and decompression block or circuit, which may be used to encode and decode an intra frame. An encoder 514 may be an encoder block or circuit, such as the neural encoder part of an auto-encoder neural network. A decoder 516 may be a decoder block or circuit, such as the neural decoder part of an auto-encoder neural network. An intra-coding block or circuit 518 may be a block or circuit performing some intermediate steps between encoder and decoder, such as quantization, entropy encoding, entropy decoding, and/or inverse quantization.

A deep loop filter block or circuit 520. This block or circuit performs filtering of reconstructed data, in order to enhance it.

A decode picture buffer block or circuit 522. This block or circuit is a memory buffer, keeping the decoded frame, for example, reconstructed frames 524 and enhanced reference frames 526 to be used for inter prediction.

An inter-prediction block or circuit 528. This block or circuit performs inter-frame prediction, for example, predicts from frames, for example, frames 532, which are temporally nearby. An ME/MC 530 performs motion estimation and/or motion compensation, which are two key operations to be performed when performing inter-frame prediction. ME/MC stands for motion estimation/motion compensation.

In this example (Option 1), the forward and inverse transforms were replaced with two neural networks. Also, the loop filter is a neural network.

Option 2 (also referred to as end-to-end learned coding): re-design the whole pipeline as a neural network auto-encoder with a quantization and lossless coding in the middle part, as follows:

Encoder NN (also referred to as neural network based encoder, or NN encoder): performs a non-linear transformation of the input. The output is typically referred to as latent tensor.

Quantization and lossless encoding of the encoder NN's output.

Lossless decoding and dequantization. Decoder NN (also referred to as neural network based decoder, or NN decoder): performs a non-linear inverse transformation from dequantized latent tensor to a reconstructed input.

It is to be understood that even in end-to-end learned approaches, there may be components which are not learned from data, such as the arithmetic codec.

More information on option 2 is provided in the following section.

### Further Information on Neural Network-Based End-to-End Learned Coding

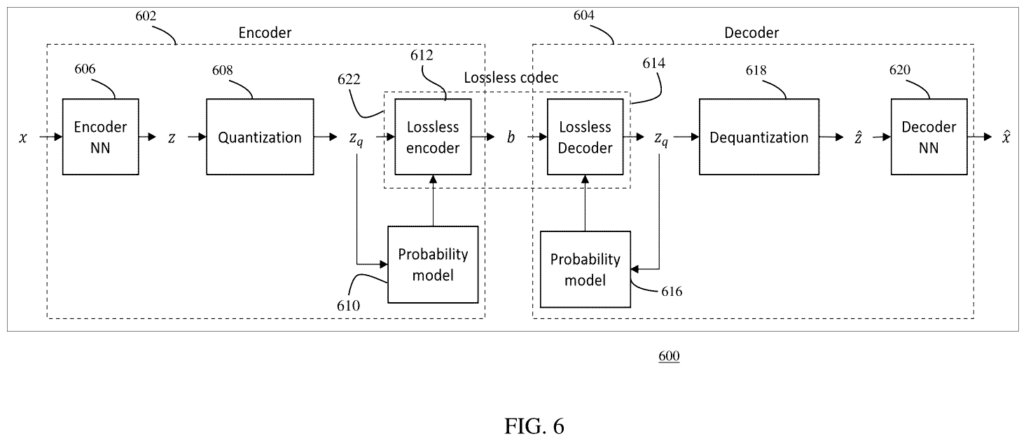

FIG. 6 illustrates an example neural network-based end-to-end learned codec, such as an end-to-end learned video codec. Even though some examples are provided with respect to coding images or videos, it is to be understood that other types of data may be coded in a similar way, such as audio, speech, text, features, and the like. As shown in FIG. 6, a typical neural network-based end-to-end learned coding system 600 includes an encoder 602 and a decoder 604.

The encoder comprises an encoder NN 606, a quantizer or quantization 608, a probability model 610, a lossless encoder 612 (for example, an arithmetic encoder). The decoder 604 comprises a lossless decoder 614 (for example, an arithmetic decoder), a probability model 616, a dequantizer or dequantization 618, a decoder NN 620.

It is to be noted that the probability model 610 present at encoder side and the probability model 616 present at decoder side may be same or substantially the same. For example, they may be two copies of the same probability model.

The lossless encoder 612 and the lossless decoder 614 form a lossless codec 622. The lossless codec 622 may be an entropy-based lossless codec. An example of lossless codec is an arithmetic codec, such as, a context-adaptive binary arithmetic coding (CABAC).

The encoder NN 606 and decoder NN 620 are typically two neural networks, or mainly comprise neural network components.

The probability models 610, 616 may also be neural networks and/or comprise mainly neural network components, and may be referred to as neural network based probability models or learned probability models.

Sometimes, the term lossless codec may refer to a system that comprise also the probability model, in addition to, for example, an arithmetic encoder and an arithmetic decoder.

The quantizer 608, the dequantizer 618, and the lossless codec 622 are typically not based on neural network components, but they may also potentially comprise neural network components.

The encoder NN 606 takes an input x, which may comprise, for example, an image to be compressed. The encoder NN 606 outputs a latent tensor z. In one example, the latent tensor may be a 3D tensor, where the three dimensions of such tensor represent a channel dimension, a vertical dimension (also sometimes referred to as height dimension) and a horizontal dimension (also sometimes referred to as width dimension). In another example, the latent tensor may be a 4D tensor, where the four dimensions of such tensor represent sample dimension (also sometimes referred to as batch dimension, which is the dimension along which different samples of data may be placed), a channel dimension, a vertical dimension (also sometimes referred to as height dimension) and a horizontal dimension (also sometimes referred to as width dimension). The latent tensor is input to the quantizer 608 or a quantization operation, obtaining a quantized latent tensor zq. The quantized latent tensor is lossless-encoded into a bitstream b by the lossless encoder 612, based also on the output of the probability model 610. In particular, the probability model 610 takes as input at least part of the quantized latent tensor and outputs an estimate of a probability, an estimate of a probability distribution, or an estimate of one or more parameters of a probability distribution for one or more elements of the quantized latent tensor. The bitstream represents an encoded or compressed version of the input x.

The bitstream is lossless-decoded by the lossless decoder 614 also based on the output of the probability model 616 present at the decoder side, obtaining a quantized latent tensor zq. The quantized latent tensor is dequantized by the dequantizer 618, obtaining a reconstructed latent tensor 2. The reconstructed latent tensor is input to the decoder NN 620, obtaining a reconstructed input x, e.g., a reconstructed version of the input x. The reconstructed input may also be referred to as reconstructed data, reconstruction, decoded data, decoded input, decoded output, and the like.

The end-to-end learned codec 600 is a simplified description of an end-to-end learned codec, and it is to be understood that more sophisticated designs or variations of this design are possible.

The neural network components, or a subset of the neural network components, of an end-to-end learned codec may be trained by minimizing a rate-distortion loss function:

$$L = D + λ R ,$$

where D is a distortion loss term, R is a rate loss term, and λ is a weight that controls the balance between the two losses.

The distortion loss term may be referred to also as reconstruction loss term, or simply reconstruction loss.

The rate loss term may be referred to simply as rate loss.

The distortion loss term measures the quality of the reconstructed or decoded output, and may comprise (but may not be limited to) one or more of the following:
Mean square error (MSE)
Structure similarity (SSIM)
MS-SSIM
Losses derived from the use of a pretrained neural network. For example, error (f1, f2), where f1 and f2 are the features extracted by a pretrained neural network for the input data and the decoded data, respectively, and error ( ) is an error or distance function, such as L1 norm or L2 norm.
Losses derived from the use of a neural network that is trained simultaneously with the end-to-end learned codec. For example, adversarial loss can be used, which is the loss provided by a discriminator neural network that is trained adversarially with respect to the codec, following the settings proposed in the context of Generative Adversarial Networks (GANs) and their variants.
Loss that is related to a performance of one or more machine analysis tasks or to an estimated performance of one or more machine analysis tasks, where the one or more machine analysis tasks may comprise classification, object detection, image segmentation, instance segmentation, etc. In one example, the estimated performance of one or more machine analysis tasks may comprise a distortion computed based at least on a first set of features extracted from an output of the decoder and a second set of features extracted from a respective ground truth data, where the first set of features and the second set of features are output by one or more layers of a pretrained feature-extraction neural network.

Multiple distortion losses may be used and integrated into D, such as a weighted sum of MSE and SSIM.

The rate loss term may be used to train the encoder NN to output a low-entropy latent tensor, or a latent tensor such that the quantized latent tensor has low entropy, or a latent tensor such that the probability distribution of the quantized latent tensor can be better estimated or predicted by the probability model.

The rate loss term may be used to train the probability model to better estimate or predict the probability distribution of the quantized latent tensor.

Examples of the rate loss terms are the following:
In one example, the rate loss term is derived from the output of the probability model, and it represents the estimated entropy of the quantized latent representation, which indicates the number of bits necessary to represent the quantized latent tensor.
A sparsification loss, e.g., a loss that encourages the quantized latent tensor to comprise many zeros. Examples are L0 norm, L1 norm, L1 norm divided by L2 norm.

In order to train the neural network components, or a subset of the neural network components, of an end-to-end learned codec, one or more of reconstruction losses may be used, and one or more rate losses may be used. In one example the one or more reconstruction losses and/or one or more rate losses are combined by means of a weighted sum. Typically, the different loss terms are weighted using different weights, and these weights determine how the final system performs in terms of rate-distortion performance. For example, when more weight is given to the reconstruction losses with respect to the rate losses, the system may learn to compress less but to reconstruct with higher accuracy (as measured by a metric that correlates with the reconstruction losses). These weights are usually considered to be hyper-parameters of the training process, and may be set manually by the person designing the training process, or automatically for example by grid search or by using additional neural networks.

In an example, the training process may be performed jointly with respect to the distortion loss D and the rate loss R. In another case, the training process may be performed in two alternating phases, where in a first phase only the distortion loss D may be used, and in a second phase only the rate loss R may be used.

For lossless video/image compression, the system may comprise only the probability model and lossless encoder and lossless decoder. The loss function would comprise only the rate loss, since the distortion loss is always zero (e.g., no loss of information).

In various embodiments, an inference phase, an inference stage, an inference time, or a test time, refers to a phase when a neural network or a codec is used for its purpose, such as encoding and decoding an input image.

### Information on Video Coding for Machines (VCM)

Reducing the distortion in image and video compression is often intended to increase human perceptual quality, as humans are considered to be the end users, e.g., consuming/watching the decoded images or videos. Recently, with the advent of machine learning, especially deep learning, there is a rising number of machines (e.g., autonomous agents) that analyze data independently from humans and that may even take decisions based on the analysis results without human intervention. Examples of such analysis are object detection, scene classification, semantic segmentation, video event detection, anomaly detection, pedestrian tracking, and the like. For example, such analysis tasks may be performed by neural networks.

It is likely that the device where the analysis takes place has multiple “machines” or neural networks (NNs). These multiple machines may be used in a certain combination which, for example, is determined by an orchestrator sub-system. The multiple machines may be used, for example, in succession, based on the output of the previously used machine, and/or in parallel. For example, a video may be analyzed by one machine (NN) for detecting pedestrians, by another machine (another NN) for detecting cars, and by another machine (another NN) for estimating the depth of all the pixels in the frames.

Example use cases and applications are self-driving cars, video surveillance cameras and public safety, smart sensor networks, smart TV and smart advertisement, person re-identification, smart traffic monitoring, drones, etc. In addition to image and video data, automatic analysis and processing has increasingly been performed for other types of data, such as audio, speech, text.

Compressing (and decompressing) data where the end user comprises machines (e.g., neural networks) is commonly referred to as compression or coding for machines. In the case of video data, it is referred to as video compression or coding for machines (VCM).

Compressing for machines may differ from compressing for humans, for example, with respect to the algorithms and technology used in the codec, or the training losses used to train any neural network components of the codec, or the evaluation methodology of codecs.

It is to be understood that, when considering the case of coding for machines, the term “receiver-side” or “decoder-side” may refer to a physical entity, an abstract entity, or a device which includes one or more machines, and runs these one or more machines on some encoded and eventually decoded video representation which is encoded by another physical or abstract entity or device, the “encoder-side device”.

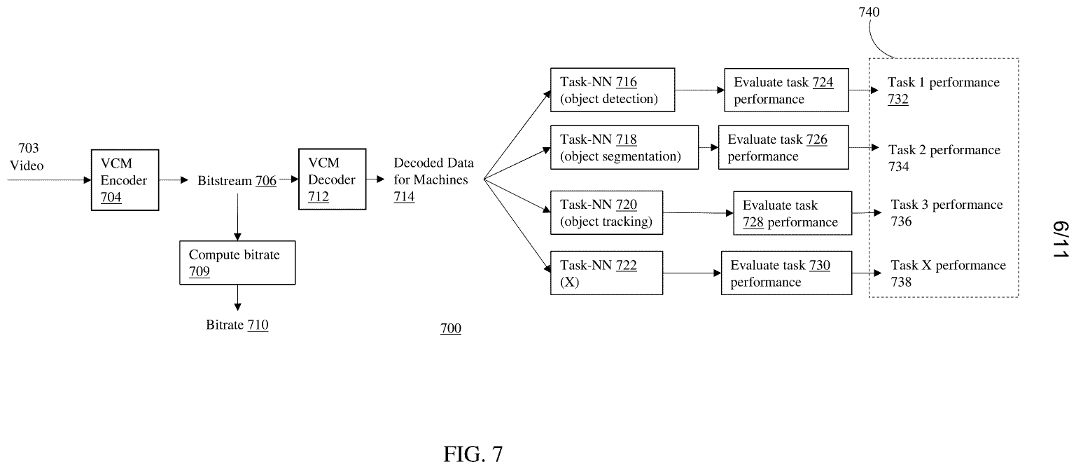

FIG. 7 illustrates an example pipeline 700 performing video coding for machines. A VCM encoder 704 encodes the input video 703 into a bitstream 706. A bitrate 710 may be computed 709 from the bitstream 706 in order to evaluate the size of the bitstream 706. A VCM decoder 712 decodes the bitstream 706 by the VCM encoder 704. The output 714 of the VCM decoder 712 is referred in FIG. 7 as “Decoded data for machines”. The output 714 may be considered as the decoded or reconstructed video. However, in some implementations of this pipeline 700, this output 714 may not have the same or similar characteristics as the original video 703 which was input to the VCM encoder 704. For example, the output 714 may not be easily understandable by a human by simply rendering the data onto a screen. The output 714 of VCM decoder 712 is then input to one or more task neural networks (716, 718, 720, 722). In FIG. 7, for the sake of illustrating that there may be any number of task-NNs, there are three example task-NNs, namely a task-NN 716 for object detection, a task-NN 718 for object segmentation, a task-NN 3 for object tracking, and a non-specified one (Task-NN X 722). The goal of VCM is to obtain a low bitrate while guaranteeing that the task-NNs (716, 718, 720, 722) still perform well in terms of the evaluation metric associated to each task.

As shown in FIG. 7, a performance (732) of the first task (e.g., object detection) is evaluated (724) and a performance (734) of the second task (e.g., object segmentation) is evaluated (726), a performance (736) of the third task (e.g., object tracking) is evaluated (728), and a performance (738) of the unspecified task is evaluated (730). The evaluated performances (732, 734, 736, 738) are collectively given as 740.

It is to be understood that, in some cases, the VCM decoder may not be present. In an example, the machines are run directly on the bitstream. In another example, the VCM decoder may comprise only a lossless decoding stage, and the lossless decoded data is provided as input to the machines. In yet some other cases, the VCM decoder may comprise a lossless decoding stage following by a dequantization operation, and the loss-decoded and dequantized data is provided as input to the machines.

When a conventional video encoder, such as a H.266/VVC encoder, is used as a VCM encoder, one or more of the following approaches may be used to adapt the encoding to be suitable to machine analysis tasks:
One or more regions of interest (ROIs) may be detected. An ROI detection method may be used. For example, ROI detection may be performed using a task NN, such as an object detection NN. In some cases, ROI boundaries of a group of pictures or an intra period may be spatially overlaid and rectangular areas may be formed to cover the ROI boundaries. The detected ROIs (or rectangular areas, likewise) may be used in one or more of the following ways:
   The quantization parameter (QP) may be adjusted spatially in a manner that ROIs are encoded using finer quantization step size(s) than other regions. For example, QP may be adjusted CTU-wise.
   The video is preprocessed to contain only the ROIs, while the other areas are replaced by one or more constant values or removed.
   The video is preprocessed so that the areas outside the ROIs are blurred or filtered.
   A grid is formed in a manner that a single grid cell covers a ROI. Grid rows or grid columns that contain no ROIs are downsampled as preprocessing to encoding.
Quantization parameter of the highest temporal sublayer(s) is increased (e.g., a coarser quantization is used) when compared to practices for human watchable video.
The original video is temporally downsampled as preprocessing prior to encoding. A frame rate upsampling method may be used as postprocessing subsequent to decoding when machine analysis at the original frame rate is desired.
A filter is used to preprocess the input to the conventional encoder. The filter may be a machine learning based filter, such as a convolutional neural network.

It is to be understood that, in the context of video coding for machines, the terms “machine vision”, “machine vision task”, “machine task”, “machine analysis”, “machine analysis task”, “computer vision”, “computer vision task”, “task network” and “task” may be used interchangeably.

Also, it is to be understood that, in the context of video coding for machines, the terms “machine consumption” and “machine analysis” may be used interchangeably.

### Information on Neural Network Based Filtering

A neural network may be used for filtering or processing input data. Such a neural network may be referred to as a neural network based filter, a NN filter, a filter. A NN filter may comprise one or more neural networks, and/or one or more components that may not be categorized as neural networks.

The purpose of a NN filter may comprise, (but may not be limited to, visual enhancement, colorization, upsampling, super-resolution, inpainting, temporal extrapolation, generating content, and the like.

In some video codecs, a neural network may be used as filter in the encoding and decoding loop (also referred to simply as coding loop), and it may be referred to as neural network loop filter, or neural network in-loop filter. The NN loop filter may replace all other loop filters of an existing video codec, or may represent an additional loop filter with respect to the already present loop filters in an existing video codec.

In one example, a codec is a modified VVC/H.266 compliant codec (e.g., a VVC/H.266 compliant codec that has been modified and thus it may not be compliant to the VVC/H.266) that comprises one or more NN loop filters. An input to the one or more NN loop filters may comprise at least a reconstructed block or frames (simply referred to as reconstruction) or data derived from a reconstructed block or frame (e.g., the output of a conventional loop filter). The reconstruction may be obtained based on predicting a block or frame (e.g., by means of intra-frame prediction or inter-frame prediction) and performing residual compensation. The one or more NN loop filters may enhance the quality of at least one of their input, so that a rate-distortion loss is decreased. The rate may indicate a bitrate (estimate or real) of the encoded video. The distortion may indicate a pixel fidelity distortion such as the following:
Mean-squared error (MSE)
Mean absolute error (MAE)
Mean Average Precision (mAP) computed based on the output of a task NN (such as an object detection NN) when the input is the output of the post-processing NN.
Other machine task-related metric, for tasks such as object tracking, video activity classification, video anomaly detection, etc.

The enhancement may result into a coding gain, which may be expressed for example in terms of BD-rate or BD-PSNR.

### Terminology

Terms frame, picture and image may be used interchangeably.

For example, the input and output to an end-to-end learned codec may be pictures. The input and output of a NN filter may be pictures.

It is to be understood that also the term block, when it means a portion of a picture, may be simply referred to as frame or picture or image. In other words, at least some of the embodiments herein, even when described as applied to a picture, may be applicable also to a block, e.g., to a portion of a picture.

Some example problems addressed by the various embodiments comprise how to design and train a single end-to-end (E2E) learned codec, such as an E2E learned image or video codec, so that it can code an input at one of several possible rate-distortion points or trade-offs.

In other words, given the single E2E learned codec, it is possible to use it for achieving different bitrates and different reconstruction qualities.

In one example, the codec may be run or executed two times on the same input, where the first time the codec codes the input to a first bitrate and first reconstruction quality, and where the second time the codec codes the input to a second bitrate and second reconstruction quality. In an example, the first bitrate is lower than the second bitrate and the first reconstruction quality is lower than the second reconstruction quality, or the other way around (the first bitrate is higher than the second bitrate and the first reconstruction quality is higher than the second reconstruction quality).

### General Information

For the sake of simplicity, in at least some of the embodiments, image is considered as the data type. However, the proposed embodiments can be extended to other types of data such as video, audio, and etc.

It is to be understood that some of the embodiments described herein may be applied to other codecs than to an end-to-end learned image codec. In one example, some of the embodiments described herein may be applied to an end-to-end learned inter-frame codec, e.g., an end-to-end learned codec that encodes and decodes frames based on one or more other frames of a video.

Some of the embodiments described herein may be applied to an end-to-end learned video codec.

It is to be understood that at least some of the embodiments described herein may be applied to a lossless codec that may comprise an entropy-based lossless codec, such as an arithmetic codec, and a neural network based probability model, where the probability model may provide probability estimates or an estimated probability distribution for one or more symbols to be encoded and/or decoded by the entropy-based lossless codec.

A probability model that comprises mainly neural network components is considered, and is referred to as neural network based probability model, or learned probability model, or simply as probability model (PM).

### Embodiments on Adapting the Probability Model for Variable Bitrate

In one embodiment, a neural network based probability model (or learned probability model) that is part of a lossy or lossless codec may be adapted based at least on one or more adaptation signals so that the bitrate of the bitstream that is output by the encoder of the codec depends on the adaptation signal. Different adaptation signals or different values of the adaptation signals may result in the encoder producing bitstreams of different bitrates.

In one embodiment, a neural network based probability model that is part of a lossy or lossless codec may be adapted based at least on one or more adaptation signals so that a quality or quality level of an output of the decoder of the codec depends on the adaptation signal, where the quality or quality level may be measured based on one or more quality metrics. Different adaptation signals or different values of the adaptation signals may result in the decoder producing outputs of different qualities or quality levels.

In one embodiment, a learned probability model that is part of a lossy or lossless codec may be adapted based at least on one or more adaptation signals so that the codec is a variable bitrate codec, or a codec that supports encoding and/or decoding in multiple bitrates and/or multiple reconstruction qualities.

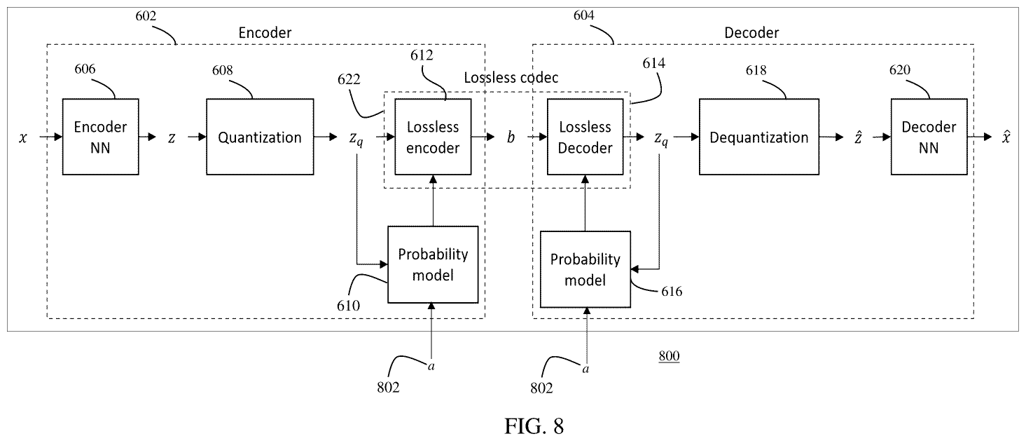

FIG. 8 illustrates an example neural network-based end-to-end learned codec 800, such as an end-to-end learned video codec, based on an embodiment. The end-to-end learned codec 800 comprises the end-to-end learned codec 600 with adaptation signal a (e.g., adaptation signal 802) being provided to the learned probability models 610 and 612.

### Embodiments on how the Adaptation Signal is Used

In the following embodiments, for simplicity, it is assumed that the one or more adaptation signals are just one.

In an embodiment, the adaptation signal may be concatenated to one or more inputs to the learned probability model.

In an example, an input to the probability model (PM) is a quantized latent tensor, where the latent tensor was output by a neural network encoder. The quantized latent tensor is 3 dimensional (3D), where one dimension is for height, one dimension is for width, one dimension is for the channels. The adaptation signal is a 3D tensor with same height and width as the quantized latent tensor, whereas the number of channels of the adaptation signal may be same as or different from the number of channels of the quantized latent tensor. The adaptation signal is concatenated to the quantized latent tensor across the channel dimension, resulting into an adapted latent tensor. The adapted latent tensor is input to the PM.

In an embodiment, the adaptation signal may modulate one or more inputs to the learned probability model.

In an example, the adaptation signal multiplies the quantized latent tensor that is input to the PM. In another example, the adaptation signal is added to the quantized latent tensor. In yet another example, the adaptation signal comprises a first adaptation signal and a second adaptation signal, where the first adaptation signal multiplies the quantized latent tensor, resulting into a first adapted latent tensor, and where the second adaptation signal is added to the first adapted latent tensor resulting into a second adapted latent tensor, and where the second adapted latent tensor represents the modulated input to the PM.

In an embodiment, the adaptation signal may modulate one or more intermediate tensors of the learned probability model.

In an example, the probability model is a neural network that comprises a set of layers, where at least some of the layers output an intermediate output, such as a feature tensor. The adaptation signal is used to modulate one or more feature tensors that are output by some of the layers, for example, by multiplication, by addition, or both.

In an embodiment, the adaptation signal is one or more weights or parameters and may be used to update or replace respective one or more weights or parameters of the learned probability model.

### Embodiments on how the Adaptation Signal is Obtained

In at least some of the embodiments, the terms “offline stage”, “offline phase”, “offline” may refer to a phase in which the codec is being developed, such as when the neural network components of the codec, such as the learned probability model, are trained.

In an embodiment, the adaptation signal may be derived from a target bitrate or a target reconstruction quality.

In an embodiment, the adaptation signal may be determined offline by means of a training process.

In an example, two or more adaptation signals comprise two or more tensors. The values of the two or more tensors may be learned by means of gradient descent based optimization or minimization of respective two or more rate-distortion loss functions with respect to the two or more tensors, where the two or more rate-distortion functions use respective two or more different lambda values, where a lambda value is multiplied by the rate term in the rate-distortion loss function. After the two or more adaptation signals are determined, they may be used at inference time to achieve respective two or more bitrates or two or more qualities.

In an embodiment, the adaptation signal may be an output of one or more neural network layers, where the weights or parameters of the one or more neural network layers are determined offline by means of a training process. During training, the input to the one or more neural network layers may be derived from the lambda value that is used to weight the rate term of the rate-distortion loss function. The lambda value may be changed during training, for example randomly or pseudo-randomly. In an example, the input to the one or more neural network layers is a one-hot encoding of the lambda value. At inference time, the input to the one or more neural network layers may be chosen by a user based on the desired bitrate and/or quality to be achieved by the codec.

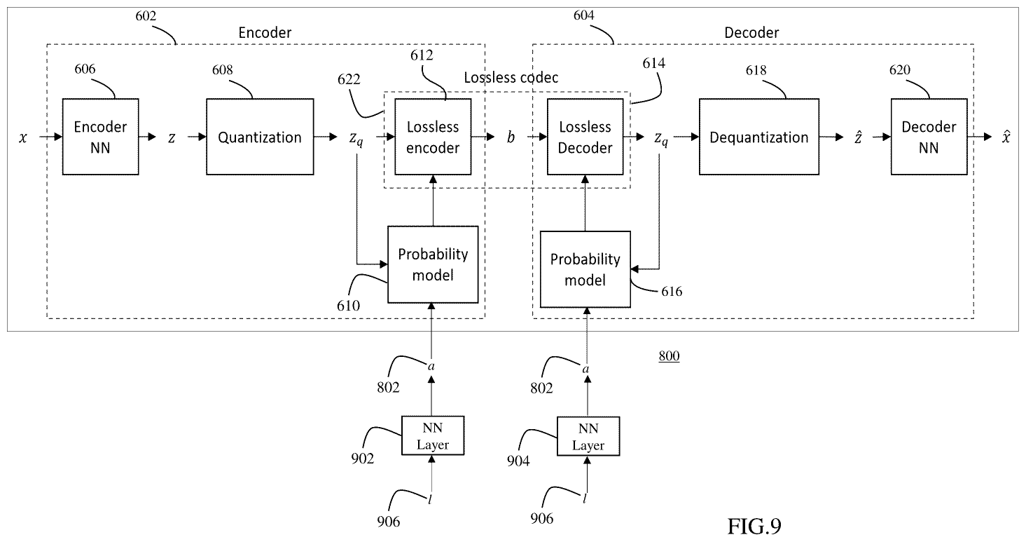

FIG. 9 illustrates an example neural network-based end-to-end learned codec 900, such as an end-to-end learned video codec, based on another embodiment. In an example of this embodiment, the end-to-end learned codec 900 comprises the end-to-end learned codec 800 with a set of neural network layers (NN layers) 902 and 904. In this example, the adaptation signal a (e.g., the adaptation signal 802) is output by the set of NN layers and an input l (e.g., the input 906) to the set of neural network layers is provided by a user and may indicate a bitrate or quality determined or decided by the user.

In one example, there may be two sets of neural network layers, where a first set outputs a first adaptation signal and a second set outputs a second adaptation signal, and where the first adaptation signal is multiplied by an input or an intermediate output of the PM, and where the second adaptation signal is added to an input or an intermediate output of the PM.

In one example, an input to the one or more neural network layers is a small-size tensor, such as a 1D array, and the output of the one or more neural network layers is a bigger-size tensor, such as a 3D array. The 1D array may have as many elements as the number of channels of the tensor to which the adaptation signal output by the one or more neural network layers is applied. The 3D array may have the same shape as the tensor to which the adaptation signal is applied, for example in terms of number of channels, height and width. Thus, the one or more neural network layers expand an initial adaptation signal (the 1D array) into a final adaptation signal (the 3D array). This may be beneficial, for example, when the adaptation signal needs to be signaled from an encoder to a decoder; in order to minimize the bitrate required by such signal, only a small-size initial adaptation signal may be signaled, and at decoder side the initial adaptation signal is expanded into a final adaptation signal of required size. The final adaptation signals represent the adaptation signal that is output by the one or more neural network layers.

In one embodiment, the adaptation signal may be determined online, e.g., at inference time, by optimizing an optimization objective with respect to the adaptation signal.

In one example, the adaptation signal comprises a tensor that is concatenated to an input to the PM, and the tensor is learned or determined by means of gradient descent based optimization of an optimization objective by using backpropagation, where the optimization objective is a rate-distortion loss function.

In one embodiment, the adaptation signal may be output by one or more neural network layers, where parameters of the one or more neural network layers are learned or determined at inference time, e.g., in an online phase, by optimizing an optimization objective with respect to the parameters of the one or more neural network layers.

In one embodiment, the adaptation signal may be the same or substantially the same as a signal that is used to adapt the latent tensor that is output by a neural network based encoder or that is used to adapt the quantized latent tensor.

In one embodiment, the adaptation signal may be output by one or more first neural network layers, where one or more parameters of the one or more neural network layers are generated by one or more second neural network layers, and where the input to the one or more second neural network layers may be an initial adaptation signal, or one or more values derived from a lambda value that was used to weight the rate term of a rate-distortion loss function, or a value that represents a target bitrate or target reconstruction quality.

### Embodiments on Format of the Adaptation Signal

In an embodiment, the adaptation signal may comprise a 1D tensor, or 1D array.

In an example, the size of the 1D array is the number of channels of the tensor that the adaptation signal adapts or modulates, such as, the number of channels of an input to the PM or the number of channels of an intermediate output of the PM.

In an embodiment, the adaptation signal may comprise a tensor with same size as the tensor that it adapts or modulates.

In an example, the adaptation signal may be a 3D tensor, where one dimension (also referred to as channel dimension) spans over the channels of the tensor, one dimension (also referred to as height or vertical dimension) spans over the vertical spatial elements, and one dimension (also referred to as width or horizontal dimension) spans over the horizontal spatial elements. In another example, the adaptation signal may be a 4D tensor, with dimensions for batch of samples, channels, height, width.

### Embodiments on Signaling

In an embodiment, an adaptation signal, or one or more values from which an adaptation signal may be derived, is signaled from an encoder in or along a bitstream, and is received by a decoder from or along the bitstream. The adaptation signal may be used at encoder side for adapting a probability model that is used to produce estimated probabilities for one or more symbols to encode, and may be used at decoder side for adapting a probability model that is used to produce estimated probabilities for one or more symbols to decode.

In an embodiment, an encoder may signal in or along a bitstream, and a decoder may receive, from or along the bitstream, information about a bitrate or quality. The information about the bitrate or quality is used to derive an adaptation signal and the adaptation signal is used to adapt one or more features of a probability model, such as input or one or more of internal signals of the probability model.

In an embodiment, an encoder may signal, in or along a bitstream, and a decoder may receive, from or along the bitstream, information about the type of adaptation to be performed on a probability model. In an example, a type of adaptation comprises concatenating an adaptation signal with an input to the PM. In an example, a type of adaptation comprises concatenating an adaptation signal with one or more internal signals of the PM, such as one or more feature tensors that are output by respective one or more layers of the PM.

In an embodiment, an encoder may signal, in or along a bitstream, and a decoder may receive, from or along the bitstream, information about how an adaptation signal may be derived from one or more values. In an example, the information may indicate that the adaptation signal may be derived by applying one or more neural network layers to the one or more values. In another example, the information may indicate that the one or more values are to be directly used for modulating an input to the PM or an internal signal of the PM.

In an embodiment, an encoder may signal, in or along a bitstream, and a decoder may receive, from or along the bitstream, a residual of an adaptation signal. The residual may be combined, for example, by means of a sum operation, with a predicted adaptation signal that is predicted at decoder side. The combined adaptation signal may be used to adapt the probability model in order to achieve a desired bitrate and/or reconstruction quality.

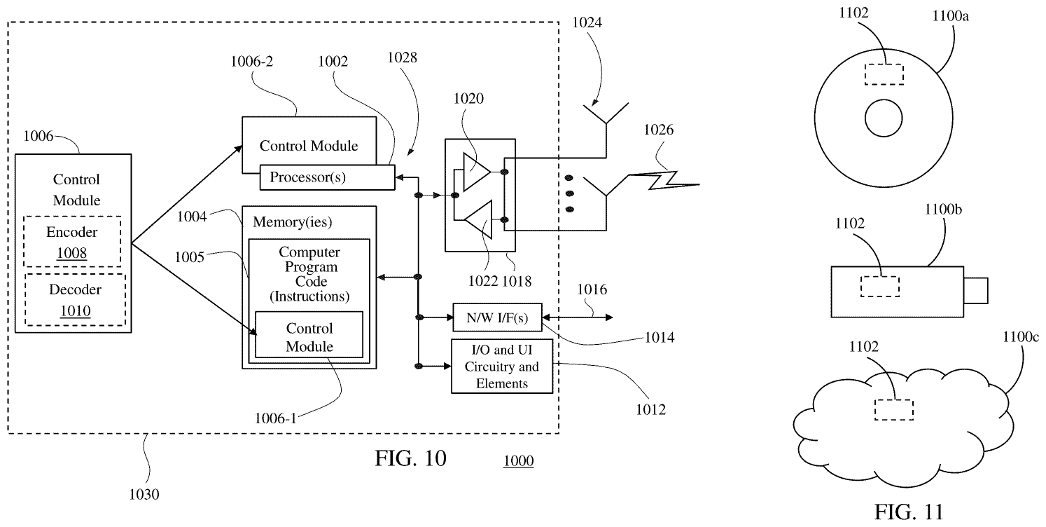

FIG. 10 is an example apparatus 1000, which may be implemented in hardware, configured to implement the examples described herein. The apparatus 1000 comprises at least one processor 1002 (e.g., an FPGA and/or CPU), at least one memory 1004 including computer program code 1005, the computer program code 1005 having instructions to carry out the methods described herein, wherein the at least one memory 1004 and the computer program code 1005 are configured to, with the at least one processor 1002, cause the apparatus 1000 to implement circuitry, a process, component, module, or function (implemented with control module 1006) to implement the examples described herein, including implementing end-to-end learned codec for multiple bitrates and/or reconstruction quality. Optionally included encoder 1008 of the control module 1006 implements encoding based on the examples described herein, and optionally included decoder 1010 implements decoding based on the examples described herein. The at least one memory 1004 may be a non-transitory memory, a transitory memory, a volatile memory (e.g. RAM), or a non-volatile memory (e.g., ROM).

The apparatus 1000 includes a display and/or I/O interface 1012, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1000 includes one or more communication e.g. network (N/W) interfaces (I/F(s)) 1014. The communication I/F(s) 1014 may be wired and/or wireless and communicate over the Internet/other network(s) via any communication technique including via one or more links 1016. The communication I/F(s) 1014 may comprise one or more transmitters or one or more receivers.

The transceiver 1018 comprises one or more transmitters 1020 and one or more receivers 1022. The transceiver 1018 and/or communication I/F(s) 1014 may comprise standard well-known components such as an amplifier, filter, frequency-converter, (de)modulator, and encoder/decoder circuitries and one or more antennas, such as antennas 1024 used for communication over wireless link 1026.

The control module 1006 of the apparatus 1000 comprises one of or both parts 1006-1 and/or 1006-2, which may be implemented in a number of ways. The control module 1006 may be implemented in hardware as control module 1006-1, such as being implemented as part of the at least one processor 1002. The control module 1006-1 may be implemented also as an integrated circuit or through other hardware such as a programmable gate array. In another example, the control module 1006 may be implemented as control module 1006-2, which is implemented as computer program code (having corresponding instructions) 1005 and is executed by the at least one processor 1002. For instance, the at least one memory 1004 store instructions that, when executed by the at least one processor 1002, cause the apparatus 1000 to perform one or more of the operations as described herein. Furthermore, the at least one processor 1002, the at least one memory 1004, and example algorithms (e.g., as flowcharts and/or signaling diagrams), encoded as instructions, programs, or code, are means for causing performance of the operations described herein.

The apparatus 1000 to implement the functionality of control module 1006 may correspond to any of the apparatuses depicted herein. Alternatively, apparatus 1000 and its elements may not correspond to any of the other apparatuses depicted herein, as apparatus 1000 may be part of a self-organizing/optimizing network (SON) node or other node, such as a node in a cloud.

The apparatus 1000 may also be distributed throughout the network including within and between apparatus 1000 and any network element (such as a base station and/or terminal device and/or user equipment).

Interface 1028 enables data communication and signaling between the various items of apparatus 1000, as shown in FIG. 10. For example, the interface 1028 may be one or more buses such as address, data, or control buses, and may include any interconnection mechanism, such as a series of lines on a motherboard or integrated circuit, fiber optics or other optical communication equipment, and the like. Computer program code (e.g. instructions) 1005, including control module 1006 may comprise object-oriented software configured to pass data or messages between objects within computer program code 1005. The apparatus 1000 need not comprise each of the features mentioned, or may comprise other features as well. The various components of apparatus 1000 may at least partially reside in a housing 1030, or a subset of the various components of apparatus 1000 may at least partially be located in different housings, which different housings may include housing 1030.

FIG. 11 shows a schematic representation of non-volatile memory media 1100a (e.g. computer/compact disc (CD) or digital versatile disc (DVD)) and 1100b (e.g. universal serial bus (USB) memory stick) and 1100c (e.g. cloud storage for downloading instructions and/or parameters 1102 or receiving emailed instructions and/or parameters 1102) storing instructions and/or parameters 1102 which when executed by a processor allows the processor to perform one or more of the operations of the methods described herein. Instructions and/or parameters 1102 may represent or correspond to a non-transitory computer readable medium.

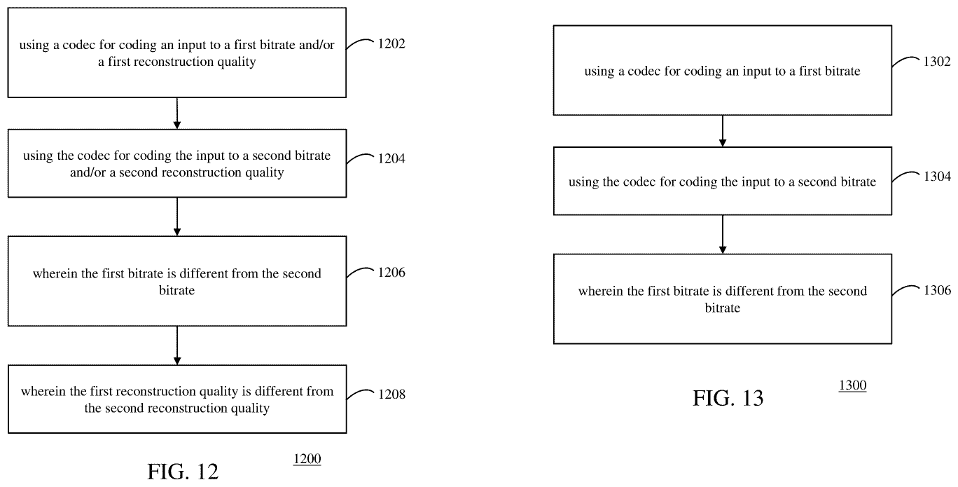

FIG. 12 is an example method 1200 performed with an encoder or a decoder, based on the examples described herein. At 1202, the method 1200 includes using a codec for coding an input to a first bitrate and/or a first reconstruction quality. At 1204, the method 1200 includes using the codec for coding the input to a second bitrate and/or a second reconstruction quality. At 1206, the method 1200 includes wherein the first bitrate is different from the second bitrate. In an example, the first bitrate may be higher than the second bitrate. Alternatively or additionally, At 1208, the method 1200 includes wherein the first reconstruction quality is different from the second reconstruction quality. In an example, the first reconstruction quality may be higher than the second reconstruction quality.

In an embodiment, the method 1200 may further include coding the input to a third bitrate and/or a third reconstruction quality, wherein the third bitrate is different from the first bitrate and the second bitrate, and/or wherein the third reconstruction quality is different from the first reconstruction quality and the second reconstruction quality. In an example, the first bitrate may be higher than the second bit rate and the third bitrate; and the second bitrate may be higher than the third bitrate. In an example, the first reconstruction quality is higher than the second reconstruction quality and the third reconstruction quality; and the second reconstruction quality is higher than the third reconstruction quality. It is to be noted that the relationships between the first, second and third reconstruction qualities; and the relationship between the first, second and third bitrates are provided as examples and other relationships are possible.

The method 1200 may be performed with an apparatus, such as the apparatus 100, 1000, or the apparatuses depicted in FIG. 3 and FIG. 4.

FIG. 13 is an example method 1300 performed with an encoder, based on the examples described herein. At 1302, the method 1300 includes using a codec for coding an input to a first bitrate. At 1304, the method 1300 includes using the codec for coding the input to a second bitrate. At 1306, the method 1300 includes, wherein the first bitrate is different from the second bitrate. In an example the first bitrate is higher than the second bitrate.

In an embodiment, the method 1300 may further include coding the input to a third bitrate, wherein the third bitrate is different from the first bitrate and the second bitrate. In an example, the first bitrate may be higher than the second bit rate and the third bitrate; and the second bitrate may be higher than the third bitrate. It is to be noted that the relationships between the first, second and third bitrates are provided as an example, and other relationships are possible.

The method 1300 may be performed with an encoding apparatus, such as the apparatus 100, 1000, or the apparatuses depicted in FIG. 3 and FIG. 4, for example, the transmitting apparatus 406 with the encoder 402, or the apparatus 400 with the encoder 402.

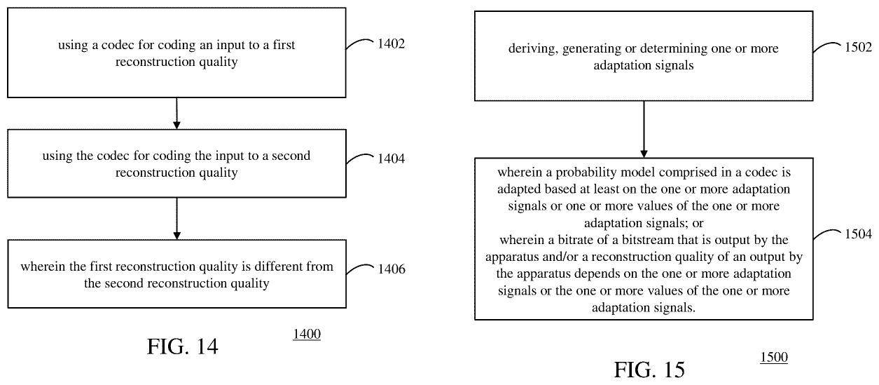

FIG. 14 is an example method 1400 performed with a decoder, based on the example embodiments described herein. At 1402, the method 1400 includes using a codec for coding an input to a first reconstruction quality. At 1404, the method 1400 includes using the codec for coding the input to a second reconstruction quality. At 1406, the method 1400 includes wherein the first reconstruction quality is different from the second reconstruction quality.

In an embodiment, the method 1400 may further include coding the input to a third reconstruction quality, wherein the third reconstruction quality is different from the first reconstruction quality and the second reconstruction quality. In an example, the first reconstruction quality may be higher than the second reconstruction quality and the third reconstruction quality; and the second reconstruction quality may be higher than the third reconstruction quality. It is to be noted that the relationships between the first, second and third reconstruction qualities are provided as an example, and other relationships are possible.

The method 1400 may be performed with a decoding apparatus, such as the apparatus 100, 1000, or the apparatuses depicted in FIG. 3 and FIG. 4, for example, the receiving apparatus 410 with the decoder 412, or the apparatus 400 with the decoder 412.

FIG. 15 is an example method performed with an encoder or a decoder, based on the examples described herein. At 1502, the method 1500 includes deriving, generating or determining one or more adaptation signals. At 1504, the method 1500 includes wherein a probability model comprised in a codec is adapted based at least on the one or more adaptation signals or one or more values of the one or more adaptation signals; or wherein a bitrate of a bitstream that is output by the apparatus and/or a reconstruction quality of an output by the apparatus depends on the one or more adaptation signals or the one or more values of the one or more adaptation signals

The method 1500 may be performed with an apparatus, such as the apparatus 100, 1000, or the apparatuses depicted in FIG. 3 and FIG. 4.

As described above, FIGS. 12 to 15 include flowcharts of an apparatus (e.g. 100, 1000, or any other apparatuses described herein), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g. 112 or 1004) of an apparatus employing an embodiment of the present invention and executed by processing circuitry (e.g., 110 or 1002) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowchart(s) of FIGS. 12 to 15. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Some embodiments have been described in relation to one or more neural networks performing visual temporal extrapolation. It is to be understood that embodiments can be realized with any generative modelling neural networks.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, and the like.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even when the software or firmware is not physically present. This description of ‘circuitry’ applies to uses of this term in this application. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device.

Circuitry or Circuit: As used in this application, the term ‘circuitry’ or ‘circuit’ may refer to one or more or all of the following:
(a) hardware-only circuit implementations (such as implementations in only analog and/or digital circuitry); and
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example, and when applicable to the particular claim element, a baseband integrated circuit or processor integrated circuit for a mobile device or a similar integrated circuit in server, a cellular network device, or other computing or network device.

What is claimed is:

1. An apparatus comprising:
at least one processor; and
at least one memory storing instructions that, when executed by the at least one processor, cause the apparatus at least to perform:
deriving, generating or determining one or more adaptation signals;
wherein a probability model comprised in a codec is adapted based at least on the one or more adaptation signals or one or more values of the one or more adaptation signals; or
wherein a bitrate of a bitstream that is output by the apparatus and/or a reconstruction quality of an output by the apparatus depends on the one or more adaptation signals or the one or more values of the one or more adaptation signals.

2. The apparatus of claim 1, wherein the apparatus is further caused to perform concatenating the one or more adaptation signals to one or more inputs to the probability model.

3. The apparatus of claim 1, wherein an input of one or more inputs to the probability model comprises a quantized latent tensor, wherein the quantized latent tensor is 3 dimensional (3D) representing height, width, and channels, and wherein an adaptation signal of the one or more adaptation signals comprises a 3D tensor with same or substantially same height and width as the quantized latent tensor, and wherein a number of channels of the adaptation signal is same as or different from a number of channels of the quantized latent tensor, and wherein the apparatus is further caused to perform:
concatenating the adaptation signal to the quantized latent tensor across a channel dimension to generate an adapted latent tensor; and
providing the adapted latent tensor as an input to the probability model.

4. The apparatus of claim 1, wherein the one or more adaptation signals modulate one or more inputs to the probability model.

5. The apparatus of claim 1, wherein one or more inputs to the probability model comprise one or more quantized latent tensors, and wherein the one or more adaptation signals are multiplied by the one or more quantized latent tensors.

6. The apparatus of claim 1, wherein one or more inputs to the probability model comprise one or more quantized latent tensors, and wherein the one or more adaptation signals are added to the one or more quantized latent tensors.

7. The apparatus of claim 1, wherein the probability model comprises a neural network comprising a set of layers, wherein at least a subset of the set of layers output one or more feature tensors, and wherein the one or more adaptation signals are used to modulate one or more feature tensors.

8. The apparatus of claim 1, wherein the one or more adaptation signals comprise one or more weights or parameters and are used to update or replace respective one or more weights or parameters of the probability model.

9. The apparatus of claim 1, wherein the one or more adaptation signals are derived based on a target bitrate or a target reconstruction quality.

10. The apparatus of claim 1, wherein the one or more adaptation signals are generated by one or more neural network layers, wherein weights or parameters of the one or more neural network layers are determined offline by means of a training process.

11. The apparatus of claim 1, wherein the one or more adaptation signals are determined online by optimizing an optimization objective with respect to the one or more adaptation signals.

12. The apparatus of claim 3, wherein the apparatus is further caused to perform: signaling, in or along the bitstream, the one or more adaptation signals, or the one or more values from which the one or more adaptation signals are derived, and wherein the one or more adaptation signals are used at an encoder side to adapt the probability model that is used to produce estimated probabilities for one or more symbols to be encoded, and are used at decoder side to adapt a probability model that is used to produce the estimated probabilities for one or more symbols to be decoded.

13. The apparatus of claim 1, wherein the apparatus is further caused to perform: signaling, in or along the bitstream, information about the bitrate or quality, wherein the information about the bitrate or quality is used to derive, generate or determine the one or more adaptation signals, and wherein the one or more adaptation signals are used to adapt one or more features of the probability model.

14. The apparatus of claim 1, wherein the apparatus is further caused to perform: signaling, in or along the bitstream, information about a type of adaptation to be performed on the probability model based at least on the one or more adaptation signals.

15. The apparatus of claim 1, wherein the apparatus is further caused to perform:
receiving, from or along the bitstream, the one or more adaptation signals, or the one or more values from which the one or more adaptation signals are derived, and wherein the one or more adaptation signals are used at an encoder side to adapt the probability model that is used to produce estimated probabilities for one or more symbols to be encoded; and
adapting the probability model to produce the estimated probabilities for one or more symbols to be decoded.

16. The apparatus of claim 3, wherein the apparatus is further caused to perform:
receiving, from or along the bitstream, information about the bitrate or reconstruction quality;
deriving, generating or determining the one or more adaptation signals based at least on the information; and
using the one or more adaptation signals for adapting one or more features of the probability model comprised in the codec, wherein a quality of an output of a decoder of the codec depends on the one or more adaptation signals, and wherein different adaptation signals result in the decoder producing outputs of different qualities.

17. The apparatus of claim 1, wherein the apparatus is further caused to perform: receiving, from or along the bitstream, information about a type of adaptation to be performed on the probability model based at least on the one or more adaptation signals.

18. The apparatus of claim 1, wherein the apparatus is further caused to perform: receiving, from or along the bitstream, information about how the one or more adaptation signals are derived from the one or more values.

19. A method comprising:
deriving, generating or determining one or more adaptation signals;
wherein a probability model comprised in a codec is adapted based at least on the one or more adaptation signals or one or more values of the one or more adaptation signals; or
wherein a bitrate of a bitstream that is output by an encoder and/or a reconstruction quality of an output by a decoder depends on the one or more adaptation signals or the one or more values of the one or more adaptation signals.

20. A non-transitory computer readable medium comprising program instructions that, when executed by an apparatus, cause the apparatus to perform:
deriving, generating or determining one or more adaptation signals;
wherein a probability model comprised in a codec is adapted based at least on the one or more adaptation signals or one or more values of the one or more adaptation signals; or
wherein a bitrate of a bitstream that is output by an encoder and/or a reconstruction quality of an output by a decoder depends on the one or more adaptation signals or the one or more values of the one or more adaptation signals.
